(19) United States
(12) Patent Application Publication
(10) Pub. No.: US 2006/0140162 A1
(43) Pub. Date: Jun. 29, 2006

(54) Alternate-location content delivery apparatus, methods and computer program products

(76) Inventor: Yojak Vasa, Cary, NC (US)

Correspondence Address: MYERS BIGEL SIBLEY & SAJOVEC, P.A., P.O. BOX 37428, RALEIGH, NC, 27627, US

(21) Appl. No.: 11/021,236

(22) Filed: Dec. 23, 2004

(51) Int. Cl. H04J 3/08

(52) U.S. Cl. 370/338; 370/401

(57) ABSTRACT

A radio signal including a plurality of audio segments is transmitted. Responsive to a user selection of at least one of the audio segments at a first location that receives the radio signal, such as a mobile terminal or other radio receiver, information related to the at least one of the audio segments is transmitted to a second location, such as an electronic mailbox. The radio signal may include an audio descriptor of a content item, such as a headline, abstract and/or sample of the item, and transmitting information related to the at least one of the audio segments to a second location may include transmitting the content item and/or a link thereto.

### BACKGROUND OF THE INVENTION

The present invention relates to information systems, methods and computer program products and, more particularly, to apparatus, methods and program products for delivery of electronic content.

Recent years have seen the development of a wide variety of forms for on-demand delivery of news, music, movies, and other content. Such content is now available over a plethora of channels, including those offered by satellite and cable television and radio services and those provided over the World Wide Web.

Because of the increasing multiplicity of media outlets, it has become desirable to provide users with tools to navigate and control media sources. Accordingly, several techniques have been developed to allow users to identify and select such media sources. For example, in the Internet environment, users may use predefined and/or user-customized web portals to display media sources that conform to particular user interests. On-air menus and viewing guides are often provided by satellite and cable services to facilitate user selection of programming provided by those services.

Interactive audio systems for delivering content have been proposed. For example, U.S. Pat. No. 6,775,358 to Breitenbach et al. describes an audio content delivery system in which a session server consults pre-stored caller preferences to generate a source file of caller-specific audio content, and then conducts an interactive playback session that presents the content to a caller. In response to certain caller utterances, the system may create a follow-up source file containing appropriate supplementary audio content. Caller preferences, such as which audio content is provided and/or the order in which selected audio content is to be provided in a call, may be established in an enrollment/configuration process conducted via the Internet, telephone or other form of communication.

U.S. Pat. No. 6,199,076 to Logan et al. describes an audio program and message distribution system in which a host system organizes and transmits program segments to client subscriber locations. The host organizes the program segments by subject matter and creates scheduled programming in accordance with preferences associated with each subscriber. Program segments are associated with descriptive subject matter segments, and the subject matter segments may be used to generate both text and audio cataloging presentations to enable the user to more easily identify and select desirable programming. A playback unit at the subscriber location reproduces the program segments received from the host and includes mechanisms for interactively navigating (e.g., skipping and rewinding) among the program segments.

U.S. Pat. No. 6,529,584 to Ravago et al. describes an audio program delivery system that delivers navigable audio programs. A user replay device, e.g., a cellular telephone, is used to access a content database according to previously established user preferences. Audio provided to the user may include audio links that are selectable by the user. For example, the audio links may be special audio content segments that allow the user to respond and transmit a command to the system while the audio segment is playing so as to initiate the retrieval and replay of an audio program that is associated with the audio link on the user replay device.

### SUMMARY OF THE INVENTION

In some embodiments of the present invention, methods of delivering electronic content, such as text, audio and/or video, are provided. A radio signal including a plurality of audio segments is transmitted. Responsive to a user selection of at least one of the audio segments at a first location that receives the radio signal, such as a mobile terminal or other radio receiver, information related to the at least one of the audio segments is transmitted to a second location, such as an electronic mailbox. The radio signal may include an audio descriptor of a content item, such as a headline, abstract and/or sample of the item, and transmitting information related to the at least one of the audio segments to a second location may include transmitting the content item and/or a link thereto.

According to some embodiments of the present invention, transmitting a radio signal including a plurality of audio segments includes transmitting a radio signal including an audio descriptor of a non-audio content item, and transmitting information related to the at least one of the audio segments to a second location includes transmitting the non-audio content item and/or a link thereto. In further embodiments, transmitting a radio signal including a plurality of audio segments includes transmitting the radio signal from a mobile communications network, and transmitting information related to the at least one of the audio segments to a second location includes transmitting the information related to the at least one of the audio segments responsive to a user selection at a mobile terminal receiving the radio signal. In still further embodiments, transmitting a radio signal including a plurality of audio segments includes transmitting a streaming audio feed including a series of audio descriptors of content items from a mobile communications network, and transmitting information related to the at least one of the audio segments to a second location includes transmitting a content item and/or a link thereto to an electronic mailbox responsive to a user selection of an audio descriptor of the streaming audio feed at a mobile terminal.

According to some embodiments of the present invention, the radio signal includes respective identifiers for the respective audio segments. Transmitting information related to the at least one of the audio segments to a second location is preceded by receiving an identifier associated with the at least one of the audio segments from the first location, and transmitting information related to the at least one of the audio segments to a second location includes transmitting information identified by the received identifier. Transmitting information related to the at least one of the audio segments to a second location may be preceded by receiving an identification of the second location from the first location.

In further embodiments of the present invention, methods of controlling delivery of electronic content are provided. A plurality of audio segments is received from a content delivery server at a radio terminal via a radio signal. At least one of the received audio segments is played. A user selection of a played audio segment is accepted. An identifier of the selected audio segment is transmitted from the radio terminal to the content delivery server to cause delivery of information related to the selected audio segment to a location other than the radio terminal.

According to additional embodiments of the present invention, an apparatus for delivering electronic content includes a content delivery server configured to support transmission of a radio signal including a plurality of audio segments and, responsive to a user selection of at least one of the audio segments at the first location that receives the radio signal, to transmit information related to the at least one of the audio segments to a second location. The plurality of audio segments may include an audio descriptor of a content item and the information relating to at least one of the audio segments may include the content item and/or a link thereto. The plurality of audio segments may include an audio descriptor of a non-audio content item and the information related to the at least one of the audio segments may include the non-audio content item and/or a link thereto.

The content delivery server may be configured to support transmission of the radio signal from a mobile communications network and to transmit the information related to the at least one of the audio segments responsive to a user selection at a mobile terminal receiving the radio signal. For example, the content delivery server may be configured to transmit a radio signal including a streaming audio feed including a series of audio descriptors of content items from a mobile communications network and to transmit a content item and/or a link thereto to an electronic mailbox responsive to a user selection of an audio descriptor in the streaming audio feed at a mobile terminal

In further embodiments of the present invention, a radio terminal includes a radio receiver configured to receive a radio signal including a plurality of audio segments from a content delivery server. The terminal further includes a content delivery client operatively associated with the radio receiver and configured to play at least one of the received audio segments, to accept a user selection of a played audio segment and to transmit an identifier of the selected audio segment to the content delivery server to cause delivery of information related to the selected audio segment to a location other than the radio terminal. The plurality of audio segments may include an audio descriptor of a content item and the information related to the selected audio segment may include the content item and/or a link thereto. The radio receiver may include a radio transceiver configured to receive the radio signal from a mobile communications network and to transmit the identifier to the content delivery server via the mobile communications network. The radio signal may include a streaming audio feed including a series of audio descriptors of content items. The content delivery client may be configured to play the streaming audio feed, to accept a user selection of an audio descriptor in the played streaming audio feed, and to cause transmission of an identifier of the selected audio descriptor to the content delivery server via the radio transceiver and the mobile communications network to cause delivery of a content item and/or a link thereto to an electronic mailbox.

According to further embodiments of the present invention, computer program products for delivering electronic content are provided. A computer program product may include computer program code embodied in a computer readable medium, the computer program code including program code configured to support transmission of a radio signal including a plurality of audio segments and program code configured, responsive to a user selection of at least one of the audio segments at a first location that receives the radio signal, to transmit information related to the at least one of the audio segments to a second location. In additional embodiments, a computer program product for controlling delivery of electronic content from a radio terminal includes program code configured to receive a plurality of audio segments from a content delivery server via a radio signal received at the radio terminal, program code configured to play at least one of the received audio segments, program code configured to accept a user selection of a played audio segment, and program code configured to transmit an identifier of the selected audio segment from the radio terminal to the content delivery server to cause delivery of information related to the selected audio segment to a location other than the radio terminal.

### BRIEF DESCRIPTION OF THE DRAWINGS

FIGS. 1-3 are schematic diagrams illustrating apparatus and operations for electronic content delivery according to various embodiments of the present invention.

FIGS. 4 and 5 are flowcharts illustrating exemplary electronic content delivery operations according to various embodiments of the present invention.

FIG. 6 is a schematic diagram illustrating apparatus and operations for electronic content delivery according to further embodiments of the present invention.

FIG. 7 is a flowchart illustrating exemplary content delivery control operations according to further embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a “radio terminal” includes cellular or other communications devices with or without a multi-line display; Personal Communications System (PCS) terminals that may combine a voice and data processing, facsimile and/or data communications capabilities; Personal Digital Assistants (PDA) that can include a radio frequency transceiver and a pager, Internet/Intranet access, Web browser, organizer, calendar and/or a global positioning system (GPS) receiver; and/or conventional laptop and/or palmtop computers or other appliances, which include a radio frequency transceiver. As used herein, “radio terminal” also includes “mobile terminals” that may be portable, transportable, installed in a vehicle (aeronautical, maritime, or land-based), or situated and/or configured to operate locally and/or in a distributed fashion at any other location(s) on earth and/or in space, as well as terminals designed for operation from a fixed location.

Some embodiments of the present invention arise from a realization that it may be desirable to provide audio descriptors of content items, such as newspaper or magazine articles, to a user at a first location, while providing a user with the ability to select particular content items associated with the descriptors for transmittal to an electronic mailbox or other repository at a second location, such that the user may subsequently perform a more detailed interaction with the selected content items. Thus, for example, a busy user may be able to listen to a stream of magazine or newspaper headlines on his or her cell phone while commuting between home and the office and, responsive to playing of these headlines, cause text versions of the articles (or web links thereto) to be transmitted to an email address or other repository so that they can be accessed when the user arrives at home or the office, or received and used by another user. Similar approaches could be used to deliver non-textual content, such as videos, photos or music.

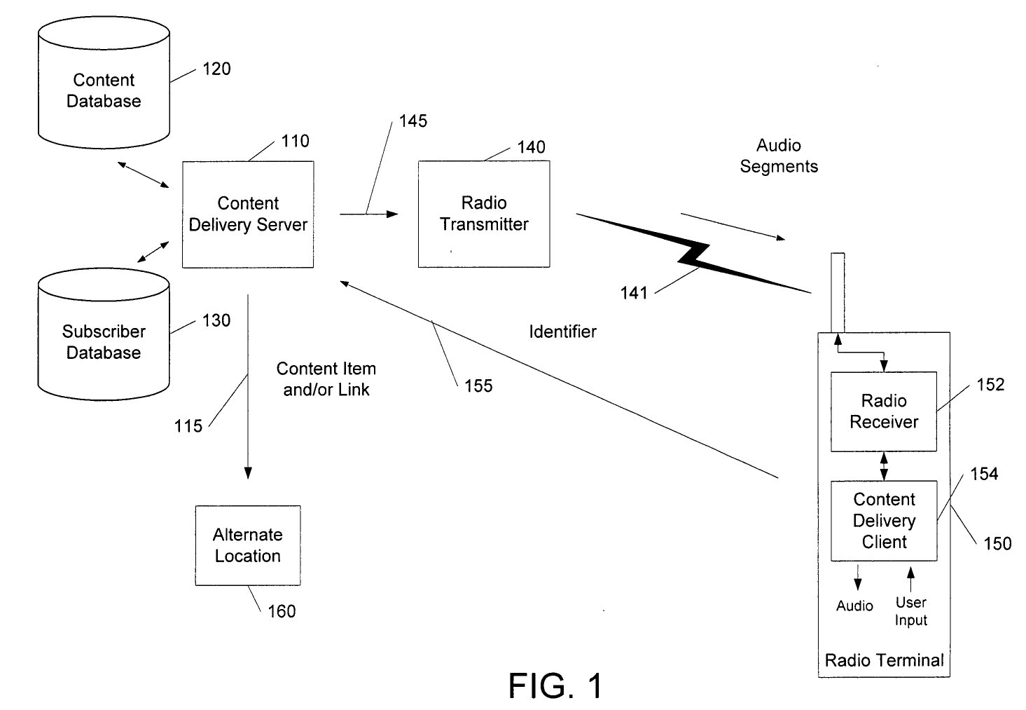

FIG. 1 illustrates a system for delivering electronic content items, such as text articles, audio files, video files and the like, according to some embodiments of the present invention. A content delivery server 110 is operatively associated with a content database 120 and a subscriber database 130. The content database 120 stores, for example, text files, audio files, video files and other content items for retrieval by the content delivery server 110. The subscriber database 130 stores information related to subscribers to the service provided, offered or otherwise supported by the content delivery server 110 and may be used, for example, in authentication and information routing functions. The content delivery server 110 is also operatively associated with a radio transceiver 140, which is configured to transmit a radio signal 141 including audio segments 145 provided by the server 110.

A radio terminal 150 includes a radio receiver 152 configured to receive the radio signal 141 including the audio segments 145, and which is coupled to a content delivery client 154 that is configured to play the audio segments 145 to a user. The content delivery client 154 is also configured to accept user inputs that select one or more of the audio segments 145, and to transmit back to the server 110 an identifier 155 of the one or more selected audio segments. The identifier 155 may, for example, be an identifier transmitted along with the segments 145. The user input may be provided in a number of different ways, such as by a keyboard input or voice command occurring contemporaneous with the playback of a particular segment(s).

In response to the identifier 155, the server 110 transmits information 115 related to the audio segment(s) identified by the identifier 155 to the alternate location 160. For example, the information transmitted to the alternate location 160 may include a content item stored in the content database 120 and associated with the identified audio segment(s), or a link thereto. The content delivery server 110 may, for example, identify the alternate location 160 by reference to the subscriber database 130 and/or the alternate location 130 could be identified in a second identifier accompanying the segment identifier 155 from the terminal 150.

It will be appreciated that the system of FIG. 1 may be implemented in a variety of different ways. For example, the server 110 may include one or more computers configured with various application programs configured to manage the content and subscriber databases 123, 130 and to communicate with the radio transmitter 140. The content database 120 may be constructed using any of a variety of different techniques, e.g., by downloading publicly available information from various media websites. Similarly, the subscriber database 130 may be constructed in a number of different ways, such as by interactive sessions with subscribers via a communications network. The radio transmitter 140 may include a discrete unit and/or may be provided in the form of a node of a distributed radio communications system, such as a base station of a public or private cellular network. The radio receiver 152 may be limited to radio receiver functions or may be part of a transceiver configured for bidirectional radio communications. The radio terminal 150 may provide the identifier 155 to the content delivery server 110 in any of a variety of different ways including, but not limited to, radio transmission, transmission via a wire interface, and/or transmission via a transferable recording media, such as a magnetic disk or flash memory. The alternate location 160 may include, for example, an electronic mailbox or some other electronic repository.

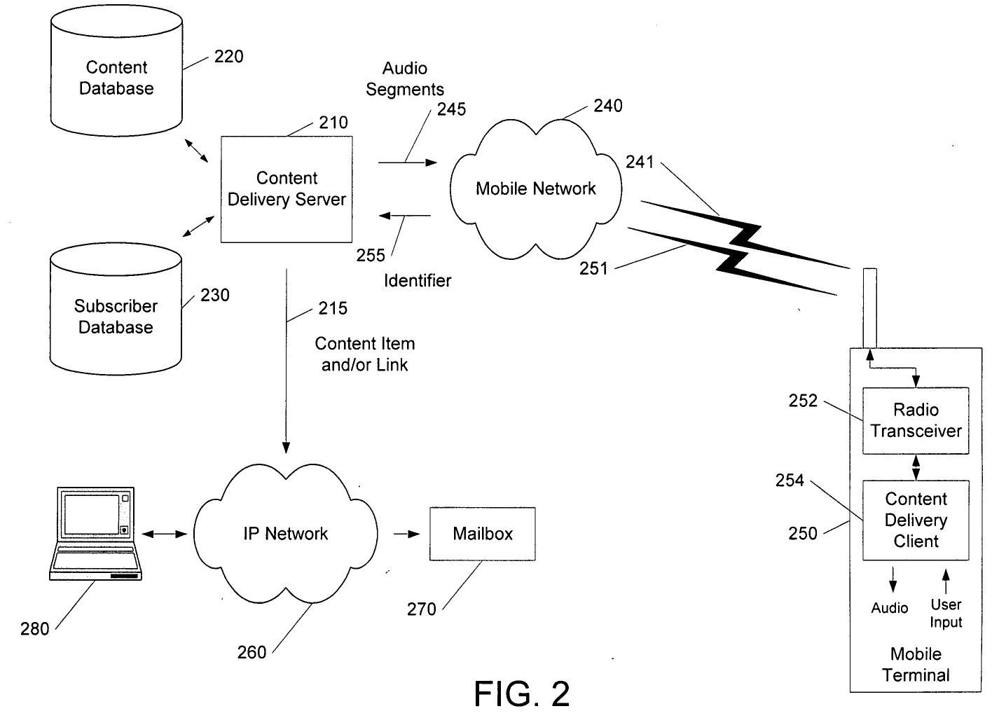

FIG. 2 illustrates an exemplary implementation according to further embodiments of the present invention, in which audio segments are delivered to a mobile terminal (e.g., a cell phone, wireless-equipped PDA, or the like) and, responsive to selection of an audio segment at the mobile terminal, an associated content item is provided to an electronic mailbox (email address). In particular, a system for content delivery includes a content delivery server 210, which is operatively associated with a content database 220 and a subscriber database 230. The content delivery server 210 transmits audio segments 245 associated with content items in the content database 220 to a mobile communications network 240, which includes the segments 245 in a radio signal 241 transmitted to a mobile terminal 250. The mobile terminal 250 includes a radio transceiver 252, which receives the radio signal 241. The radio receiver 252 is coupled to a content delivery client 254 that plays the received audio segments 245, and which accepts user inputs that select various ones of the audio segments 245. The content delivery client 254 transmits an identifier 255 for a selected audio segment back to the content delivery server 210 via a radio signal 251 transmitted between the radio receiver 252 and the mobile communications network 240. Responsive to the identifier 255, the content delivery server 210 delivers an associated content item or link thereto 215 to an electronic mailbox 270 via a network 260. Subsequently, a user at a terminal, e.g., a notebook computer 280 coupled to the network 260, may access the content item or link.

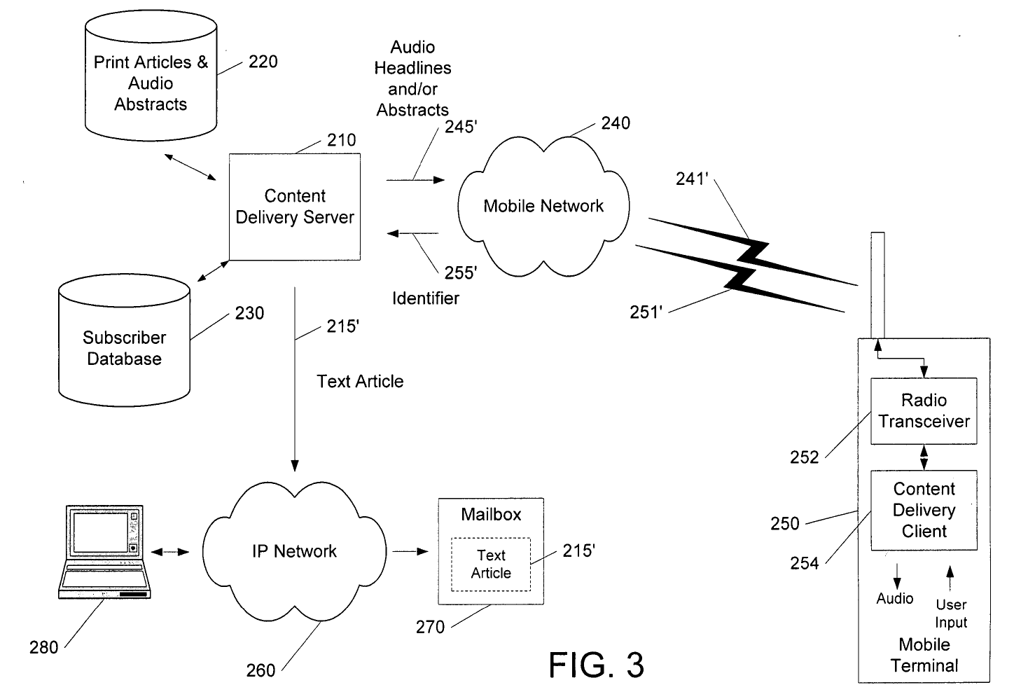

FIG. 3 illustrates how a system along the lines of FIG. 2 may be used, for example, to provide selective delivery of newspaper articles, magazine articles or similar textual content items according to further embodiments of the present invention. In particular, the content delivery server 210 may be configured to provide audio headlines and/or abstracts 245′ of text articles stored in the content database 220 to the mobile terminal 250 via a radio signal 241′ transmitted by the mobile communications network 240. Responsive to playback of the headlines or abstracts 245′, a user at the terminal 250 may select, e.g., using a keypad or voice input, one of the headlines or abstracts 245′. In response, the content delivery client 252 transmits an identifier 255′ of the selected headline or abstract back to the server 210 via a radio signal 251′ transmitted to the mobile communications network 240. Responsive to receipt of the identifier 255′, the server 210 delivers the associated text article 215′ (e.g., as embedded text or as a file attachment) in an email message transmitted to the electronic mailbox 270 via the network 260. Subsequently, a user at the access computer 280 may open the email and access the article 215′.

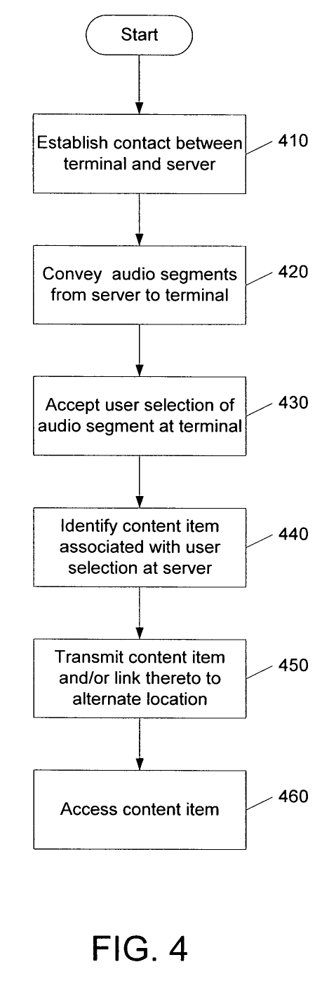

FIG. 4 illustrates exemplary operations for content delivery according to further embodiments of the present invention. After establishing radio contact between a user terminal and a content delivery server (block 410), audio segments are transferred from the server to the terminal (block 420). Responsive to user selection of an audio segment (block 430), a content item associated with the user selection is identified at the server (block 440). The identified content item and/or a link thereto is responsively transmitted to an alternate location, such as an electronic mailbox or other repository (block 450). Subsequently, the identified content items and/or a link thereto may be accessed at the alternate location (block 460).

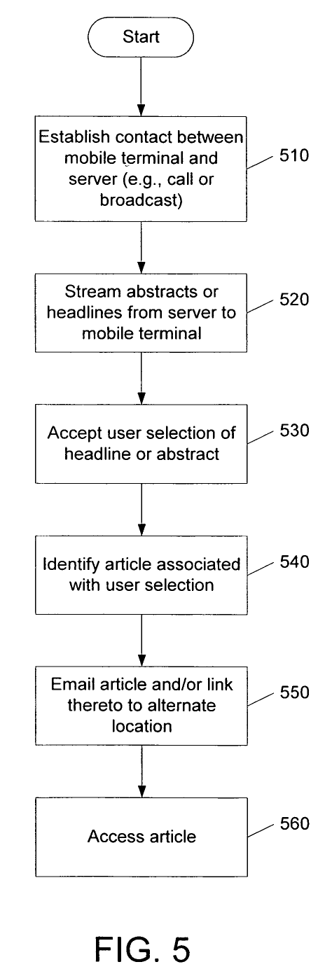

FIG. 5 illustrates exemplary content delivery operations for textual content using a mobile terminal according to further embodiments of the present invention. The mobile terminal establishes radio contact with a content delivery server by, for example, calling a predefined telephone number or by tuning into a predefined channel, such as a broadcast channel configured for delivery of audio descriptors (block 510). The server streams a series of audio headlines or abstracts to the terminal (block 520). Responsive to user selection of a particular headline or abstract (block 530), the server identifies an article associated with the identified headline (block 540). The server transmits the identified article and/or a link thereto to an email address (block 550), where a user may subsequently access the article (block 560).

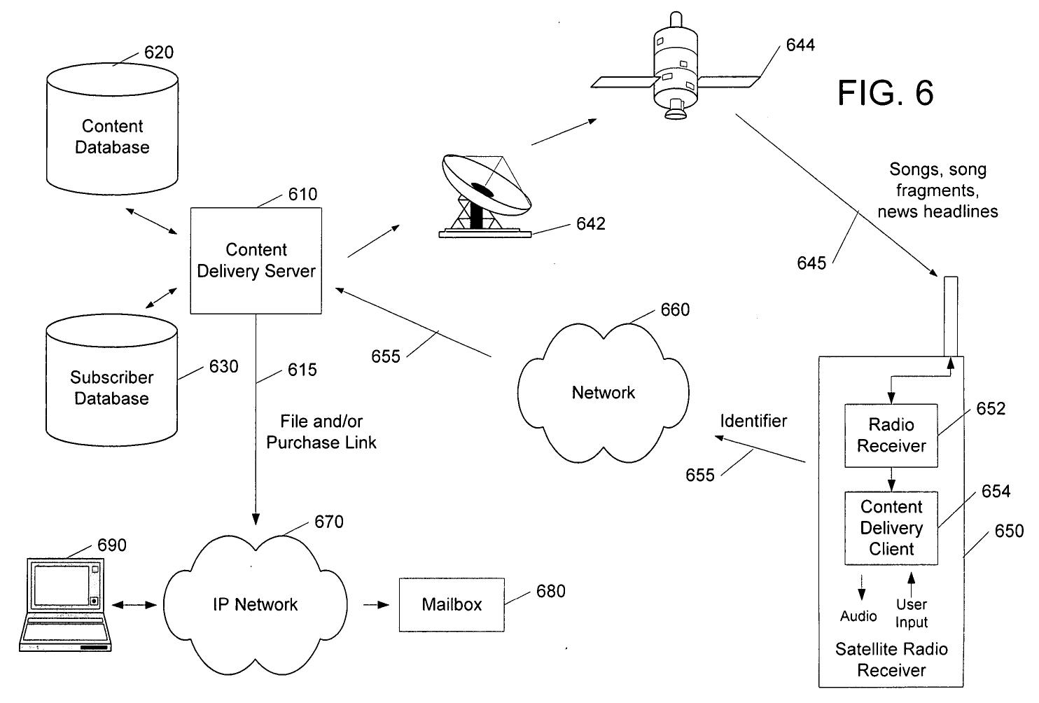

It will be understood that the present invention may be applied to the delivery of content other than textual material. For example, FIG. 6 illustrates a system according to some embodiments of the present invention for delivering information, such as music files, textual material and/or purchasing links, for content referenced by a satellite radio system. In particular, a content delivery server 610 is coupled to a satellite 644 via a ground antenna 642, and provides audio segments 645, such as songs, song portions, news headlines, or the like, to a content delivery client 654 of a satellite radio receiver 650 via the satellite 644 and a radio receiver 652. Responsive to user selection of a particular segment, the content delivery client 654 transmits an identifier 655 to the server 610. Assuming a one-way satellite-to-terminal interface, the client 654 might communicate the identifier 655 via, for example, a land-based network 660 and/or a transferable recording medium.

Responsive to receipt of the identifier 655, the server 610 transmits a content item, e.g., a music file, audio file, video file, purchasing link, or the like, associated with the selected segment to an electronic mailbox 680 via a network 670. A user at a terminal 690 may subsequently access the content item to listen to, view or otherwise process the information. For example, if a purchasing link for a song is provided in an email message to the mailbox 680, the user may click on the link in the message and complete operations required to purchase and download the song.

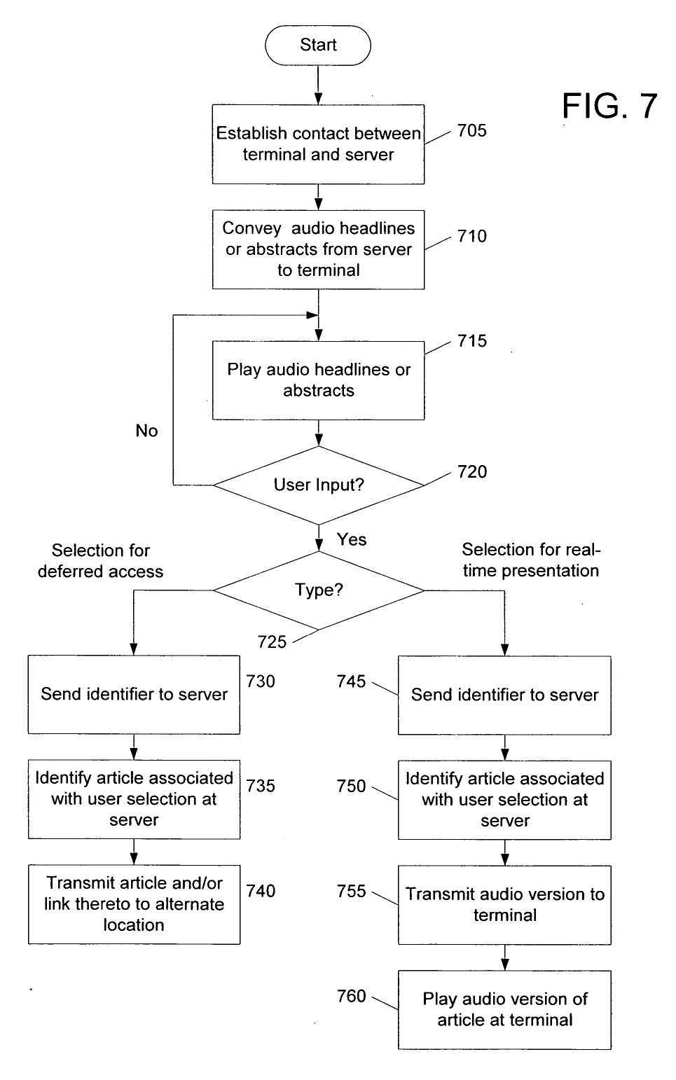

According to further embodiments of the present invention, content delivery operations along the lines described above may be combined with other features. FIG. 7, for example, shows an exemplary combination of delivery and playback control operations that may be performed by apparatus such as shown in FIGS. 1-3 and 6. After establishing radio contact between a terminal and a content delivery server (block 705), audio headlines or abstracts are transferred from the server to the terminal (block 710). The transferred headlines or abstracts are then played at the terminal (block 715).

Upon detection of a user input (block 720), different courses of action may be performed depending on the nature of the user input. If, for example, the user input represents a request to have a copy of an article associated with a selected headline or abstract sent to an alternate location for deferred access, an identifier of the selected headline or abstract is transmitted to the server (block 730), which responsively identifies the article and sends the article or a link thereto to the alternate location (e.g., an electronic mailbox) (blocks 735, 740). The user input may alternately be a request for a full-length substantially “real-time” rendition of the article associated with the selected headline or abstract at the terminal. In this case, an identifier of the selected headline or abstract may be sent to the content delivery server (block 745), which responsively identifies the associated article (block 750) and transmits an audio version of the article to the terminal (block 755). The terminal may then play the audio version of the article (block 760).

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method of delivering electronic content, the method comprising:
transmitting a radio signal including a plurality of audio segments; and
responsive to a user selection of at least one of the audio segments at a first location that receives the radio signal, transmitting information related to the at least one of the audio segments to a second location.

2. A method according to claim 1:
wherein transmitting a radio signal including a plurality of audio segments comprises transmitting a radio signal including an audio descriptor of a content item; and
wherein transmitting information related to the at least one of the audio segments to a second location comprises transmitting the content item and/or a link thereto.

3. A method according to claim 2, wherein the content item comprises a visual content item and/or an audio content item.

4. A method according to claim 2, wherein the content item comprises a text item.

5. A method according to claim 2, wherein the audio descriptor comprises a headline, abstract and/or sample for the content item.

6. A method according to claim 2, wherein transmitting the content item and/or a link thereto comprises transmitting the content item and/or the link thereto to an electronic mailbox.

7. A method according to claim 1:
wherein transmitting a radio signal including a plurality of audio segments comprises transmitting a radio signal including an audio descriptor of a non-audio content item; and
wherein transmitting information related to the at least one of the audio segments to a second location comprises transmitting the non-audio content item and/or a link thereto.

8. A method according to claim 1:
wherein transmitting a radio signal including a plurality of audio segments comprises transmitting the radio signal from a mobile communications network; and
wherein transmitting information related to the at least one of the audio segments to a second location comprises transmitting the information related to the at least one of the audio segments responsive to a user selection at a mobile terminal receiving the radio signal.

9. A method according to claim 1:
wherein transmitting a radio signal including a plurality of audio segments comprises transmitting a streaming audio feed including a series of audio descriptors of content items from a mobile communications network; and
wherein transmitting information related to the at least one of the audio segments to a second location comprises transmitting a content item and/or a link thereto to an electronic mailbox responsive to a user selection of an audio descriptor of the streaming audio feed at a mobile terminal.

10. A method according to claim 1, wherein the radio signal includes respective identifiers for the respective audio segments, wherein transmitting information related to the at least one of the audio segments to a second location is preceded by receiving an identifier associated with the at least one of the audio segments from the first location, and wherein transmitting information related to the at least one of the audio segments to a second location comprises transmitting information identified by the received identifier.

11. A method according to claim 1, wherein transmitting information related to the at least one of the audio segments to a second location is preceded by receiving an identification of the second location from the first location.

12. A method of controlling delivery of electronic content, the method comprising:
receiving a plurality of audio segments from a content delivery server at a radio terminal via a radio signal;
playing at least one of the received audio segments;
accepting a user selection of a played audio segment; and
transmitting an identifier of the selected audio segment from the radio terminal to the content delivery server to cause delivery of information related to the selected audio segment to a location other than the radio terminal.

13. A method according to claim 12, wherein the plurality of audio segments comprises an audio descriptor of a content item and wherein the information related to the selected audio segment comprises the content item and/or a link thereto.

14. A method according to claim 12:
wherein receiving a plurality of audio segments from the content delivery server at a radio terminal via a radio signal comprises receiving the radio signal at a mobile terminal from the content delivery server via a mobile communications network; and
wherein transmitting an identifier of the selected audio segment from the radio terminal to the content delivery server to cause delivery of information related to the selected audio segment to a location other than the radio terminal comprises transmitting the identifier to the content delivery server via the mobile communications network.

15. A method according to claim 12:
wherein receiving a plurality of audio segments from the content delivery server at a radio terminal via a radio signal comprises receiving a streaming audio feed including a series of audio descriptors of content items from the content delivery server via a mobile communications network;
wherein playing at least one of the received audio segments comprises playing the streaming audio feed at the terminal;
wherein accepting a user selection of a played audio segment comprises accepting a user selection of an audio descriptor of the played streaming audio feed; and
wherein transmitting an identifier of the selected audio segment from the radio terminal to the content delivery server to cause delivery of information related to the selected audio segment to a location other than the radio terminal comprises transmitting an identifier of the selected audio descriptor to the content delivery server to cause delivery of a content item and/or a link thereto to an electronic mailbox.

16. An apparatus for delivering electronic content, the apparatus comprising:
a content delivery server configured to support transmission of a radio signal including a plurality of audio segments and, responsive to a user selection of at least one of the audio segments at the first location that receives the radio signal, to transmit information related to the at least one of the audio segments to a second location.

17. An apparatus according to claim 16, wherein the plurality of audio segments comprise an audio descriptor of a content item and wherein the information relating to at least one of the audio segments comprises the content item and/or a link thereto.

18. An apparatus according to claim 16, wherein the plurality of audio segments comprises an audio descriptor of a non-audio content item and wherein the information related to the at least one of the audio segments comprises the non-audio content item and/or a link thereto.

19. An apparatus according to claim 16, wherein the content delivery server is configured to support transmission of the radio signal from a mobile communications network and to transmit the information related to the at least one of the audio segments responsive to a user selection at a mobile terminal receiving the radio signal.

20. An apparatus according to claim 16, wherein the content delivery server is configured to transmit a radio signal including a streaming audio feed including a series of audio descriptors of content items from a mobile communications network and to transmit a content item and/or a link thereto to an electronic mailbox responsive to a user selection of an audio descriptor in the streaming audio feed at a mobile terminal

21. An apparatus according to claim 16, wherein the radio signal includes respective identifiers for the respective audio segments, and wherein the content delivery server is configured to receive an identifier associated with the at least one of the audio segments from the first location and to transmit information identified by the received identifier.

22. A radio terminal comprising:
a radio receiver configured to receive a radio signal including a plurality of audio segments from a content delivery server; and
a content delivery client operatively associated with the radio receiver and configured to play at least one of the received audio segments, to accept a user selection of a played audio segment and to transmit an identifier of the selected audio segment to the content delivery server to cause delivery of information related to the selected audio segment to a location other than the radio terminal.

23. A terminal according to claim 22, wherein the plurality of audio segments comprises an audio descriptor of a content item and wherein the information related to the selected audio segment comprises the content item and/or a link thereto.

24. A terminal according to claim 22, wherein the radio receiver comprises a radio transceiver configured to receive the radio signal from a mobile communications network and to transmit the identifier to the content delivery server via the mobile communications network.

25. A terminal according to claim 24, wherein the radio signal comprises a streaming audio feed including a series of audio descriptors of content items and wherein the content delivery client is configured to play the streaming audio feed, to accept a user selection of an audio descriptor in the played streaming audio feed, and to cause transmission of an identifier of the selected audio descriptor to the content delivery server via the radio transceiver and the mobile communications network to cause delivery of a content item and/or a link thereto to an electronic mailbox.

26. A computer program product for delivering electronic content, the computer program product comprising computer program code embodied in a computer readable medium, the computer program code comprising:
program code configured to support transmission of a radio signal including a plurality of audio segments; and
program code configured, responsive to a user selection of at least one of the audio segments at a first location that receives the radio signal, to transmit information related to the at least one of the audio segments to a second location.

27. A computer program product according to claim 26:
wherein the program code configured to support transmission of a radio signal including a plurality of audio segments comprises program code configured to support transmission of a radio signal including an audio descriptor of a content item; and
wherein the program code configured to deliver information related to the at least one of the audio segments to a second location comprises program code configured to deliver the content item and/or a link thereto.

28. A computer program product according to claim 26:
wherein the program code configured to support transmission of a radio signal including a plurality of audio segments comprises program code configured to support transmission of a streaming audio feed including a series of audio descriptors of content items from a mobile communications network; and
wherein the program code configured to deliver information related to the at least one of the audio segments to a second location comprises program code configured to deliver a content item and/or a link thereto to an electronic mailbox responsive to a user selection of a an audio descriptor of the streaming audio feed at a mobile terminal.

29. A computer program product for controlling delivery of electronic content from a radio terminal, the computer program product comprising computer program code embodied in a computer readable medium, the computer program code comprising:
program code configured to receive a plurality of audio segments from a content delivery server via a radio signal received at the radio terminal;
program code configured to play at least one of the received audio segments;
program code configured to accept a user selection of a played audio segment; and
program code configured to transmit an identifier of the selected audio segment from the radio terminal to the content delivery server to cause delivery of information related to the selected audio segment to a location other than the radio terminal.

30. A computer program product according to claim 29, wherein the plurality of audio segments comprises an audio descriptor of a content item and wherein the information related to the selected audio segment comprises the content item and/or a link thereto.

31. A computer program product according to claim 29:
wherein the program code configured to receive a plurality of audio segments from the content delivery server comprises program code configured to receive a streaming audio feed including a series of audio descriptors of content items from the content delivery server via a mobile communications network;
wherein the program code configured to play at least one of the received audio segments comprises program code configured to play the streaming audio feed at the terminal;
wherein the program code configured to accept a user selection of a played audio segment comprises program code configured to accept a user selection of an audio descriptor in the played streaming audio feed; and
wherein the program code configured to transmit an identifier of the selected audio segment from the radio terminal to the content delivery server to cause delivery of information related to the selected audio segment to a location other than the radio terminal comprises program code configured to transmit an identifier of the selected audio descriptor to the content delivery server to cause delivery of a content item and/or a link thereto to an electronic mailbox.
